(19) United States
(12) Patent Application Publication
(10) Pub. No.: US 2025/0291497 A1
(43) Pub. Date: Sep. 18, 2025

(54) EMULATION OF A ONE-TIME PROGRAMMABLE MEMORY

(71) Applicant: STMicroelectronics International N.V., Geneva (CH)

(72) Inventor: Michel JAOUEN, Yvre L'eveque (FR)

(73) Assignee: STMicroelectronics International N.V., Geneva (CH)

(21) Appl. No.: 19/071,471

(22) Filed: Mar. 5, 2025

(30) Foreign Application Priority Data
Mar. 15, 2024 (FR) 2402593

(51) Int. Cl. G06F 3/06

(52) U.S. Cl. CPC G06F 3/0622; G06F 3/0652; G06F 3/0679

(57) ABSTRACT

A state of an electronic device is controlled between an initial state, a testing state and a configured state. Transitions between the initial state and the testing state are controlled by setting or resetting a first status bit in a non-volatile memory. Transitions from the initial state or from the testing state to the configured state are controlled by setting a second status bit in a one-time programmable memory. A configuration bit of the electronic device is programmed during the initial state. A first enable bit, associated with an area of a non-volatile memory of the electronic device, is programmed to a protection value as a function of a value of the configuration bit. Programming of the first enable bit is restricted to the initial state. Erasing of the first area of the non-volatile memory is restricted based on a value of the first enable bit.

### BACKGROUND

### Technical Field

The present disclosure generally concerns one-time programmable (OTP) memories, and in particular a method and a circuit for emulating an OTP memory.

### Description of the Related Art

Security mechanisms, such as for example mechanisms forbidding a return to previous versions and/or states of software (Anti RollBack), can be easily implemented on electronic devices when they are provided with a one-time programmable memory.

However, the size of one-time programmable memories depends on a plurality of parameters, such as, for example, functionalities on-board the device, the type of end use of the device, etc., and may not be sufficient for a user of the device.

### BRIEF SUMMARY

An embodiment provides a method comprising:
the programming of a first enable bit, associated with an area of a non-volatile memory of an electronic device, to a protection value; and
the forbidding of the erasing of the content of the first area of the non-volatile memory, based on the state of the first enable bit.

According to an embodiment, the protection value to which the first enable bit is programmed is a function of the state of a configuration bit and/or of at least one value associated with a state in which is placed the device among a plurality of possible states of the device.

According to an embodiment, the configuration bit is only programmable when the device is placed in a first state of the plurality of states.

According to an embodiment:
the device is placed in a second state of the plurality of states, starting from the first state, by programming of a first status bit; and
the device is placed in a third state of the plurality of states, starting from the first or from the second state, by programming of a second status bit stored in a one-time programmable memory.

According to an embodiment, the erasing of the non-volatile memory area is authorized when the device is in the first state.

According to an embodiment, the first status bit is stored in non-volatile memory.

According to an embodiment, the configuration bit is stored in a one-time programmable memory.

According to an embodiment, the configuration bit is stored in the non-volatile memory.

According to an embodiment, an additional bit is stored in a one-time programmable memory of the device and the protection value to which the first enable bit is programmed is further a function of the additional bit.

According to an embodiment, the additional bit is only programmable when the device is placed in the second state.

An embodiment provides a device comprising a non-volatile memory comprising an area associated with a first enable bit programmed to a protection value, the access for erasing to the area being forbidden based on the protection value.

According to an embodiment, the protection value to which is programmed the enable bit is a function of the value of a configuration bit, of a first status bit stored in the non-volatile memory, and of a second status bit stored in a one-time programmable memory of the device.

According to an embodiment, the configuration bit is stored in the one-time programmable memory.

According to an embodiment, the configuration bit is stored in the non-volatile memory and the one-time programmable memory further comprises an additional bit, the protection value to which is programmed the enable bit being further a function of the state of the additional bit.

According to an embodiment, the state of the first and/or of the second status bits determines a state of the device from among a first, a second, and a third state, and the configuration bit is only programmable when the device is in the first state.

In an embodiment, a method comprises controlling a state of an electronic device. The state is one of a plurality of states including an initial state, a testing state and a configured state of the electronic device. Transitions between the initial state and the testing state are controlled by setting or resetting a first status bit in a non-volatile memory of the electronic device. Transitions from the initial state or from the testing state to the configured state are controlled by setting a second status bit in a one-time programmable memory of the electronic device. A configuration bit of the electronic device is programmed, wherein programming of the configuration bit is restricted to the initial state of the electronic device. A first enable bit, associated with an area of a non-volatile memory of the electronic device, is programmed to a protection value, wherein the protection value is a function of a value of the configuration bit. Programming of the first enable bit is restricted to the initial state of the electronic device. Erasing of the first area of the non-volatile memory is restricted based on a value of the first enable bit.

In an embodiment, an electronic device comprises memory and processing circuitry coupled to the memory. The memory includes non-volatile memory and one-time programmable memory. In operation, a first enable bit stored in the memory is associated with a first area of the non-volatile memory, and erasing of the first area of the non-volatile memory is restricted based on a value of the first enable bit. The device has a plurality of states including an initial state, a testing state and a configured state. Transitions between the initial state and the testing state are controlled by setting or resetting a first status bit in the non-volatile memory. Transitions from the initial state or from the testing state to the configured state are controlled by setting a second status bit in the one-time programmable memory of the electronic device. Programming of a configuration bit stored in the memory is restricted to the initial state of the electronic device. Programming of the first enable bit is a function of a value of the configuration bit, and programming of the first enable bit is restricted to the initial state of the electronic device.

In an embodiment, a system comprises non-volatile memory, one-time programmable memory, and processing circuitry. In operation, a first enable bit is associated with a first area of the non-volatile memory, erasing of the first area of the non-volatile memory is restricted based on a value of the first enable bit. The device has a plurality of states including an initial state, a testing state and a configured state. Transitions between the initial state and the testing state are controlled by setting or resetting a first status bit in the non-volatile memory. Transitions from the initial state or from the testing state to the configured state are controlled by setting a second status bit in the one-time programmable memory. Programming of a configuration bit stored in the memory is restricted to the initial state of the electronic device. Programming of the first enable bit is a function of a value of the configuration bit, and programming of the first enable bit is restricted to the initial state of the electronic device.

In an embodiment, a non-transitory computer-readable medium's contents cause processing circuitry to perform a method. The method comprises controlling a state of an electronic device. The state is one of a plurality of states including an initial state, a testing state and a configured state of the electronic device. Transitions between the initial state and the testing state are controlled by setting or resetting a first status bit in a non-volatile memory of the electronic device. Transitions from the initial state or from the testing state to the configured state are controlled by setting a second status bit in a one-time programmable memory of the electronic device. The method includes programming a configuration bit of the electronic device, wherein programming of the configuration bit is restricted to the initial state of the electronic device, programming a first enable bit, associated with an area of a non-volatile memory of the electronic device, to a protection value, wherein the protection value is a function of a value of the configuration bit, and programming of the first enable bit is restricted to the initial state of the electronic device, and restricting erasing of the first area of the non-volatile memory based on a value of the first enable bit. In an embodiment, the contents comprise instructions executable by the processing circuitry.

### BRIEF DESCRIPTION OF THE SEVERAL VIEWS OF THE DRAWINGS

The foregoing features and advantages, as well as others, will be described in detail in the rest of the disclosure of specific embodiments given as an illustration and not limitation with reference to the accompanying drawings, in which:

FIG. 1 is a block diagram illustrating an electronic device;

FIG. 2 is a flowchart illustrating steps of an embodiment of the present disclosure; and

FIG. 3 illustrates an example of implementation of a one-time programmable memory emulation method, according to an embodiment of the present disclosure.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front,” “back,” “top,” “bottom,” “left,” “right,” etc., or relative position qualifiers, such as “top,” “bottom,” “upper,” “lower,” etc., or orientation qualifiers, such as “horizontal,” “vertical,” etc., reference is made unless otherwise specified to the orientation of the drawings.

Unless specified otherwise, the expressions “about,” “approximately,” “substantially,” and “in the order of” signify plus or minus 10%, for example, of plus or minus 5%.

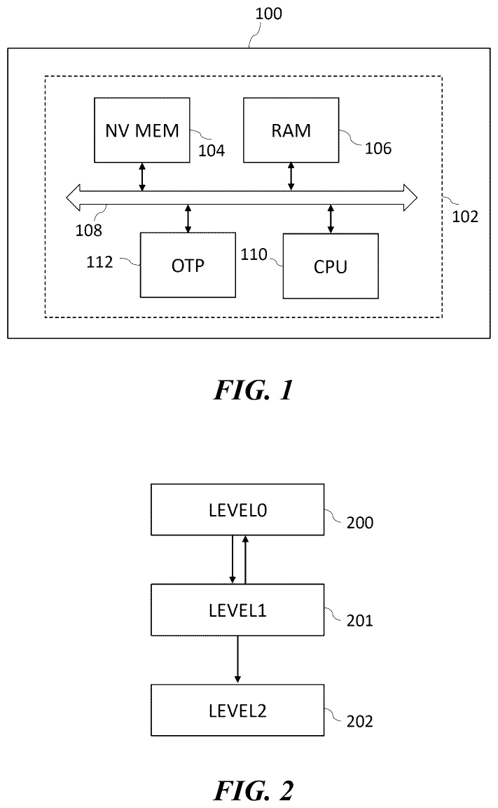

FIG. 1 is a block diagram illustrating an electronic device 100 comprising a processing circuit 102 according to an embodiment of the present disclosure.

Processing circuit 102 is, for example, an electronic card such as a microcircuit card, computer hardware, a microprocessor circuit, etc. As an example, electronic device 100, comprising processing circuit 102, is a connected object, such as a smartphone, a connected watch, etc., on which one or a plurality of applications are installed.

According to an embodiment, circuit 102 comprises a non-volatile memory 104 (NV MEM), for example of NOR Flash and/or NAND FLASH type. Circuit 102 for example further comprises a volatile memory 106 (RAM). As an example, volatile memory 106 is a RAM (Random Access Memory). Memories 104 and 106 are coupled, for example, via a bus 108.

Circuit 102 further comprises, for example, a processor 110 (CPU) coupled to bus 108. As an example, processor 110 is configured to run applications having their application codes, for example, stored in non-volatile memory 104.

According to an embodiment, circuit 102 further comprises one or a plurality of one-time programmable (OTP) memories 112, for example coupled to bus 108. As an example, memory or memories 112 are fuse-type or anti-fuse-type memories. As an example, in their initial state, the bits of memory or memories 112 have value 1. A bit of memory or memories 112 will be said to be burnt out when its value will change from 1 to 0.

As an example, memory or memories 112 are configured to, for example, burn out one or a plurality of bits at each update of a software application or firmware, for example, firmware of the device. Thereby, memory or memories 112 provide anti rollback mechanisms. In another example, memory or memories 112 are configured to burn out one or a plurality of bits when device 100 leaves an initial state, such as for example a state enabling the programming and/or the configuration of device 102, for example to be supplied to an intermediate entity between the manufacturer of circuit 102 and an end user of device 100 and/or its placing on the market.

In certain cases, the size of memories 112 is insufficient for the implementation of security mechanisms and/or the implementation of other functionalities requiring the use of a one-time programmable memory.

According to an embodiment, non-volatile memory 104 comprises one or a plurality of blocks, or sectors, configurable in such a way as to be protected against the erasing of their content. In other words, one or a plurality of blocks of non-volatile memory 104 are configurable to play the role of a one-time programmable memory.

As an example, each of the one or a plurality blocks of non-volatile memory 104 is associated with a configuration bit stored in memory 104 and/or in memories 112. The state of the configuration bit then determines whether the associated block is protected against erasing or not.

As an example, memory 104 is a NOR Flash-type memory and comprises one or a plurality of sectors protected against erasing. Each sector comprises, for example, 16 bytes. As an example, the bytes of each block initially have value 0xff. When a write request, for example originating from the processor, is required on one of these blocks, the first byte of this block is for example programmed to value 0xfe or to value 0x1. As an example, when a request is made to write the first byte at value 0xff, the erasing of the block is then required. The block being protected against erasing, the write request is then denied and the first byte of the block remains at the previously-programmed value.

As an example, memory 104 is a NAND Flash-type memory and comprises one or a plurality of sectors protected against erasing. Each sector comprises, for example, 16 payload bytes and 8 error correction code (ECC) bytes, each payload byte being then associated with 4 ECC bits. As an example, the payload and ECC bytes of each block initially have value 0xff. When a write request, for example originating from the processor, is required on one of these blocks, the first byte of this block is programmed to value 0xfe and the 4 associated ECC bits are programmed to, for example, the value corresponding to 0xfe. As an example, the second byte of this block is programmed to value 0x1 and the 4 associated ECC bits are programmed to, for example, the value corresponding to 0x1. As an example, when a request is made to write the first byte at value 0xff, the erasing of the block is then required. The block being protected against erasing, the write request is then denied and the first byte in the block remains at the previously-programmed value. Indeed, in a block of a NAND-type memory, it is possible to program the bytes of the block in the order or out of order. However, each byte is programmable only once. Indeed, for each writing of a byte, ECC bits are programmed, and the ECC bits encoding the error code then depend on the data item written in the byte. It is then for example possible to write value 0xfe in the first byte. However, if it is then desired to write a value other than 0xfe in the first byte, the writing will fail, because a memory controller (not shown in FIG. 1) of the NAND memory will check, before writing, that the byte is 0xff and that the 4 ECC bits associated with this byte are programmed to value 1. The behavior then is the same for all bytes. In other words, the behavior is the same for the 16 bytes.

In the case of a NOR-type memory, it is not possible to first write value 0xfe and then value 0x1 in the same byte. Indeed, the least significant bit of this byte would be programmed to value 0 at the first writing of 0xfe, then be programmed to value 1 at the second writing of this bit. However, the NOR-type memory technology implies the erasing of a block to reprogram a bit having value 0 to value 1.

According to an embodiment, the selection of the blocks of memory 104 for which the protection against erasing is activated is configurable only when circuit 102 is in a programming and/or configuration state. As an example, this state is an initial state of circuit 102 when it is in the hands of its manufacturer and before being handed over to, for example, an intermediate entity between the manufacturer and an end user and/or before it is placed on the market.

FIG. 2 is a flowchart illustrating steps of an embodiment of the present disclosure.

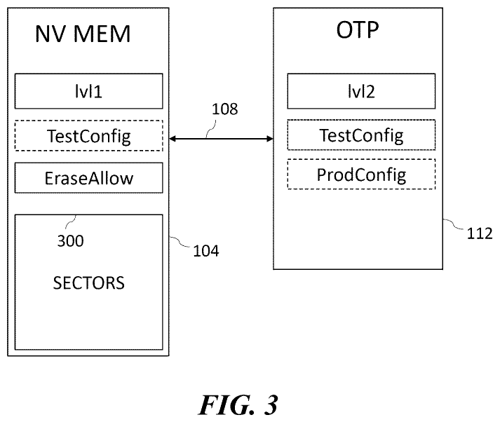

FIG. 3 illustrates an example of implementation of the one-time programmable memory emulation method, according to an embodiment of the present disclosure.

At a step 200 (LEVEL0), circuit 102 is in its initial state. As an example, circuit 102 is in the hands of its manufacturer and has not yet been handed over to an intermediate entity and/or to its end user.

For example, the initial state of the circuit is defined by the state of two status bits. As an example, when these two status bits are programmed to value 0, circuit 102 is in the initial state. As an example, the two status bits comprise a first status bit lvl1 stored in memory 104 and a second status bit lvl2 stored in one of memories 112.

According to an embodiment, when circuit 102 is in its initial state, blocks 300 (SECTORS) of memory 104 are configurable to be, in the rest of the lifetime of device 100, protected against erasing. As an example, the blocks of memory 104 are further configurable to be, in the rest of the lifetime of device 100, protected against writing. In other words, in the initial state of circuit 102, it is possible to configure the blocks 300 of memory 104 so as to prevent their erasing and/or their writing.

As an example, blocks 300 comprise 8 blocks of 16 bytes each. In the example where memory 104 is of NAND type, each of blocks 300 comprises, in addition to the 16 payload bytes, 8 error code bytes.

In an example, a byte TestConfig for configuring blocks 300 is, for example, stored in one of memories 112. Each bit of the configuration byte is then associated with one of blocks 300. The bits of the configuration byte are then programmed at step 200. As an example, when a bit of the configuration byte is burnt out, taking for example value 0, this indicates that the associated block in memory 104 is protected against erasing. Thus, once a bit of the configuration byte is burnt out, this action is irreversible.

In another example, configuration byte TestConfig is stored in memory 104. Thus, it is possible to change the configuration of blocks 300 when the write access to byte TestConfig is authorized. In this example, an additional byte ProdConfig is stored in memory 112.

As an example, the protection against erasing of a block of memory 104 is not effective when circuit 102 is in its initial state. In other words, during step 200, it is possible to modify and/or to erase the contents of a block of memory 104 protected against erasing. Thus, this enables to perform tests on the content of the protected block and to modify it if need be.

At a step 201 (LEVEL1), circuit 102 is placed in an intermediate or testing state. As an example, the transition of the circuit from the initial state to the intermediate state is performed by the programming of the first status bit lvl1 for example, stored in memory 104. As an example, when the first status bit lvl1 is programmed to value 0, circuit 102 is in the intermediate state. It is then possible to return to the initial state by reprogramming the first status bit lvl1 for example to value 1.

In the example where the configuration byte is stored in memory 104 and memories 112 comprise the additional byte ProdConfig, the intermediate entity has the option of burning out bits of the additional byte, thus indicating whether it desires for one or a plurality of blocks of blocks 300 to be protected against erasing. As an example, the write access to byte ProdConfig is authorized only during the implementation of step 201. The programming of byte ProdConfig is then definitive. Further, byte ProdConfig is programmed from the value of byte TestConfig.

At a step 202 (LEVEL2), for example, circuit 102 is placed in a final or configured state. For example, step 202 is carried out before device 100 is handed over to its end user. For example, circuit 102 is moved to the final state by programming of the second status bit lvl2 stored in memory 112, for example. For example, when the second status bit is programmed to value 0, circuit 102 is in the final state. Thus, the second status bit being included in memories 112, once circuit 102 has entered the final state, it is not possible to return to step 200 and/or to step 201.

As an example, the write access to byte TestConfig is authorized when the first status bit lvl1 and the second status bit lvl2 both have value 1, in other words when circuit 102 is in the initial state. Similarly, in the case where memories 112 comprise byte ProdConfig byte, the write access to byte ProdConfig is authorized when the first status bit lvl1 is has value 0 and the second status bit has value 1. In this example, the writing of status bit lvl2 at value 0 is can be achieved when byte ProdConfig is programmed, based on the values of byte TestConfig.

As an example, an authorization byte Erase Allow is for example stored in memory 104. The value of byte EraseAllow is, for example, calculated based on various elements stored in memory 104, such as for example status bit lvl1, the value of byte TestConfig and/or based on values stored in memory 112, such as, for example, status bit lvl2 and the value of byte ProdConfig. Byte EraseAllow is then, for example, stored in a register. The value of this byte is, for example, calculated via logic hardware, such as for example logic gates, and based on the content of memories 104 and 112. The register storing byte Erase Allow is then, for example, coupled to the memory controller. The memory controller is then configured to authorize, or not, the erasing of a block based on the value of byte EraseAllow. As an example, during the implementation of steps 200, 201, and 202, on reception of a request to erase one of the blocks of memory 104, the value of a bit, associated with the block having its erasing requested, of the authorization byte is calculated.

In the example where the configuration byte is stored in memories 112, for each block of memory 104 identified, for example by an integer x in the range from 0 to 7, an enable bit Erase Allow [x], for example, the x-th bit of the authorization byte is such that Erase Allow [x]=(LVL1 AND LVL2) OR TestConfig [x] where LVL1 is the state of the first status bit lvl1, LVL2 is the state of the second status bit lvl2, and TestConfig [x] is the state of the bit associated with block x in byte TestConfig. As an example, when bit Erase Allow [x] is equal to 0, any request to erase the associated block is denied. Thus, it is possible to erase any block during step 200. During steps 201 and/or 202, the erasing of the block identified by integer x is only authorized if the associated TestConfig [x] bit has been programmed, at step 200, to authorize an erasing of the block.

In the case where the configuration byte is stored in memory 104, the additional byte ProdConfig stored in memory 112 is only accessible for writing during step 201, in other words when circuit 102 is in the intermediate state. It is then not possible to modify the value of byte ProdConfig during the implementation of step 202, in other words when circuit 102 is in its final state.

In this example, the x-th bit of the authorization byte is then calculated as

$$EraseAllow [ x ] = ( LVL 1 AND LVL 2 ) OR ( TestConfig [ x ] AND LVL 2 ) OR ( Not ( LVL 2 ) AND ProdConfig [ x ] ) .$$

Thus, it is possible for the intermediate entity, during step 201, to modify and configure the blocks 300 protected, or not, against erasing.

Various embodiments and variants have been described. Those skilled in the art will understand that certain features of these various embodiments and variants may be combined, and other variants will occur to those skilled in the art. In particular, as concerns memories 112, although in the described embodiments, a bit of memories 112 is burnt out when its value is equal to 0, it is quite conceivable for a burnt-out bit to have value 1. Those skilled in the art will be capable of adapting the calculation of the bits of byte EraseAllow accordingly. Further, although the described examples illustrate 8 configurable blocks, each of 16 bytes, it is possible to configure a greater or smaller number of blocks. The blocks may also be of sizes different than 16 bytes. Those skilled in the art will be capable of accordingly adapting the size of the configuration and authorization bytes.

Finally, the practical implementation of the described embodiments and variants is within the abilities of those skilled in the art based on the functional indications given hereabove.

In an embodiment, a method includes: the programming of a first enable bit (Erase Allow [x]), associated with an area of a non-volatile memory (104) of an electronic device (100), to a protection value; and the forbidding of the erasing of the content of the first area of the non-volatile memory, based on the state of the first enable bit.

The protection value to which is programmed the first enable bit (Erase Allow [x]) can be a function of the state of a configuration bit (TestConfig [x]) and/or of at least one value (LVL1, LVL2) associated with one of a plurality of possible states of the device.

The configuration bit (TestConfig [x]) can be only programmable when the device is placed in a first state of the plurality of states.

The device (100) can be set to a second state of the plurality of states, from the first state, by programming of a first status bit (lvl1); and the device can be set to a third state of the plurality of states, from the first or from the second state, by programming of a second status bit (lvl2) stored in a one-time programmable memory (112).

In an embodiment, the erasing of the non-volatile memory area (104) is authorized when the device (100) is in the first state.

In an embodiment, the first status bit (lvl1) is stored in the non-volatile memory (104).

In an embodiment, the configuration bit (TestConfig [x]) is stored in a one-time programmable memory (112).

In an embodiment, the configuration bit (TestConfig [x]) is stored in the non-volatile memory (104).

In an embodiment, an additional bit (ProdConfig [x]) is stored in a one-time programmable memory (112) of the device and the protection value to which is programmed the first enable bit (EraseAllow [x]) is a function of the additional bit.

In an embodiment, the additional bit (ProdConfig [x]) is only programmable when the device (100) is placed in the second state (lvl1).

In an embodiment, a device comprises a non-volatile memory (104) including an area associated with a first enable bit (EraseAllow [x]) programmed to a protection value, the access for erasing to the area being forbidden based on the protection value.

In an embodiment, the protection value to which is programmed the enable bit (Erase Allow [x]) is a function of the value of a configuration bit (TestConfig [x]), of a first status bit (lvl1) stored in the non-volatile memory (104), and of a second status bit (lvl2) stored in a one-time programmable memory (112) of the device.

The configuration bit (TestConfig [x]) can be stored in the one-time programmable memory (112).

The configuration bit (TestConfig [x]) can be stored in the non-volatile memory (104) and the one-time programmable memory (112) can further include an additional bit (ProdConfig [x]), the protection value to which is programmed the enable bit further being a function of the state of the additional bit.

The state of the first and/or of the second status bits (lvl1, lvl2) can determine a state of the device among a first, a second, and a third state, and the configuration bit (TestConfig [x]) can be programmable only when the device is in the first state.

In an embodiment, a method comprises controlling a state of an electronic device. The state is one of a plurality of states including an initial state, a testing state and a configured state of the electronic device. Transitions between the initial state and the testing state are controlled by setting or resetting a first status bit in a non-volatile memory of the electronic device. Transitions from the initial state or from the testing state to the configured state are controlled by setting a second status bit in a one-time programmable memory of the electronic device. A configuration bit of the electronic device is programmed, wherein programming of the configuration bit is restricted to the initial state of the electronic device. A first enable bit, associated with an area of a non-volatile memory of the electronic device, is programmed to a protection value, wherein the protection value is a function of a value of the configuration bit. Programming of the first enable bit is restricted to the initial state of the electronic device. Erasing of the first area of the non-volatile memory is restricted based on a value of the first enable bit.

In an embodiment, the erasing of the first area of the non-volatile is permitted when the device is in the initial state.

In an embodiment, the configuration bit is stored in the one-time programmable memory.

In an embodiment, the configuration bit is stored in the non-volatile memory. In an embodiment, an additional bit is stored in the one-time programmable memory of the electronic device and the protection value is a function of the configuration bit and the additional bit. In an embodiment, the additional bit is only programmable when the device is placed in the testing state.

In an embodiment, an electronic device comprises memory and processing circuitry coupled to the memory. The memory includes non-volatile memory and one-time programmable memory. In operation, a first enable bit stored in the memory is associated with a first area of the non-volatile memory, and erasing of the first area of the non-volatile memory is restricted based on a value of the first enable bit. The device has a plurality of states including an initial state, a testing state and a configured state. Transitions between the initial state and the testing state are controlled by setting or resetting a first status bit in the non-volatile memory. Transitions from the initial state or from the testing state to the configured state are controlled by setting a second status bit in the one-time programmable memory of the electronic device. Programming of a configuration bit stored in the memory is restricted to the initial state of the electronic device. Programming of the first enable bit is a function of a value of the configuration bit, and programming of the first enable bit is restricted to the initial state of the electronic device.

In an embodiment, erasing of the first area of the non-volatile memory is permitted when the device is in the first state.

In an embodiment, the configuration bit is stored in the one-time programmable memory.

In an embodiment, the configuration bit is stored in the non-volatile memory. In an embodiment, an additional bit is stored in the one-time programmable memory of the electronic device and the protection value is a function of the configuration bit and the additional bit. In an embodiment, the additional bit is only programmable when the device is placed in the testing state.

In an embodiment, a system comprises non-volatile memory, one-time programmable memory, and processing circuitry. In operation, a first enable bit is associated with a first area of the non-volatile memory, erasing of the first area of the non-volatile memory is restricted based on a value of the first enable bit. The device has a plurality of states including an initial state, a testing state and a configured state. Transitions between the initial state and the testing state are controlled by setting or resetting a first status bit in the non-volatile memory. Transitions from the initial state or from the testing state to the configured state are controlled by setting a second status bit in the one-time programmable memory. Programming of a configuration bit stored in the memory is restricted to the initial state of the electronic device. Programming of the first enable bit is a function of a value of the configuration bit, and programming of the first enable bit is restricted to the initial state of the electronic device.

In an embodiment, in operation, erasing of the first area of the non-volatile memory is permitted when the device is in the initial state.

In an embodiment, the configuration bit is stored in the non-volatile memory.

In an embodiment, the processing circuitry, in operation, executes applications. In an embodiment, the system is a smart phone and the applications are smart phone applications.

In an embodiment, a non-transitory computer-readable medium's contents cause processing circuitry to perform a method. The method comprises controlling a state of an electronic device. The state is one of a plurality of states including an initial state, a testing state and a configured state of the electronic device. Transitions between the initial state and the testing state are controlled by setting or resetting a first status bit in a non-volatile memory of the electronic device. Transitions from the initial state or from the testing state to the configured state are controlled by setting a second status bit in a one-time programmable memory of the electronic device. The method includes programming a configuration bit of the electronic device, wherein programming of the configuration bit is restricted to the initial state of the electronic device, programming a first enable bit, associated with an area of a non-volatile memory of the electronic device, to a protection value, wherein the protection value is a function of a value of the configuration bit, and programming of the first enable bit is restricted to the initial state of the electronic device, and restricting erasing of the first area of the non-volatile memory based on a value of the first enable bit. In an embodiment, the contents comprise instructions executable by the processing circuitry.

In an embodiment, the configuration bit is stored in the non-volatile memory.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
controlling a state of an electronic device, wherein,
the state is one of a plurality of states including an initial state, a testing state and a configured state of the electronic device,
transitions between the initial state and the testing state are controlled by setting or resetting a first status bit in a non-volatile memory of the electronic device, and
transitions from the initial state or from the testing state to the configured state are controlled by setting a second status bit in a one-time programmable memory of the electronic device;
programming a configuration bit of the electronic device, wherein programming of the configuration bit is restricted to the initial state of the electronic device;
programming a first enable bit, associated with an area of a non-volatile memory of the electronic device, to a protection value, wherein the protection value is a function of a value of the configuration bit, and programming of the first enable bit is restricted to the initial state of the electronic device; and
restricting erasing of the first area of the non-volatile memory based on a value of the first enable bit.

2. The method according to claim 1, wherein the erasing of the first area of the non-volatile is permitted when the device is in the initial state.

3. The method according to claim 1, wherein the configuration bit is stored in the one-time programmable memory.

4. The method according to claim 1, wherein the configuration bit is stored in the non-volatile memory.

5. The method according to claim 4, wherein an additional bit is stored in the one-time programmable memory of the electronic device and wherein the protection value is a function of the configuration bit and the additional bit.

6. The method according to claim 4, wherein the additional bit is only programmable when the device is placed in the testing state.

7. An electronic device, comprising:
memory, including non-volatile memory and one-time programmable memory; and
processing circuitry coupled to the memory, wherein, in operation,
a first enable bit stored in the memory is associated with a first area of the non-volatile memory,
erasing of the first area of the non-volatile memory is restricted based on a value of the first enable bit,
the device has a plurality of states including an initial state, a testing state and a configured state,
transitions between the initial state and the testing state are controlled by setting or resetting a first status bit in the non-volatile memory,
transitions from the initial state or from the testing state to the configured state are controlled by setting a second status bit in the one-time programmable memory of the electronic device,
programming of a configuration bit stored in the memory is restricted to the initial state of the electronic device,
programming of the first enable bit is a function of a value of the configuration bit, and
programming of the first enable bit is restricted to the initial state of the electronic device.

8. The device according to claim 7, wherein, in operation, erasing of the first area of the non-volatile memory is permitted when the device is in the first state.

9. The device according to claim 7, wherein, in operation, the configuration bit is stored in the one-time programmable memory.

10. The device according to claim 7, wherein, in operation, the configuration bit is stored in the non-volatile memory.

11. The device according to claim 10, wherein, in operation, an additional bit is stored in the one-time programmable memory of the electronic device and the protection value is a function of the configuration bit and the additional bit.

12. The device according to claim 10, wherein the additional bit is only programmable when the device is placed in the testing state.

13. A system, comprising:
non-volatile memory;
one-time programmable memory; and
processing circuitry, wherein, in operation,
a first enable bit is associated with a first area of the non-volatile memory,
erasing of the first area of the non-volatile memory is restricted based on a value of the first enable bit,
the device has a plurality of states including an initial state, a testing state and a configured state,
transitions between the initial state and the testing state are controlled by setting or resetting a first status bit in the non-volatile memory,
transitions from the initial state or from the testing state to the configured state are controlled by setting a second status bit in the one-time programmable memory,
programming of a configuration bit stored in the memory is restricted to the initial state of the electronic device,
programming of the first enable bit is a function of a value of the configuration bit, and
programming of the first enable bit is restricted to the initial state of the electronic device.

14. The system according to claim 13, wherein, in operation, erasing of the first area of the non-volatile memory is permitted when the device is in the initial state.

15. The system according to claim 13, wherein, in operation, the configuration bit is stored in the non-volatile memory.

16. The system according to claim 13, wherein the processing circuitry, in operation, executes applications.

17. The system according to claim 16, wherein the system is a smart phone and the applications are smart phone applications.

18. A non-transitory computer-readable medium having contents which cause processing circuitry to perform a method, the method, comprising:
controlling a state of an electronic device, wherein,
the state is one of a plurality of states including an initial state, a testing state and a configured state of the electronic device,
transitions between the initial state and the testing state are controlled by setting or resetting a first status bit in a non-volatile memory of the electronic device, and
transitions from the initial state or from the testing state to the configured state are controlled by setting a second status bit in a one-time programmable memory of the electronic device;
programming a configuration bit of the electronic device, wherein programming of the configuration bit is restricted to the initial state of the electronic device;
programming a first enable bit, associated with an area of a non-volatile memory of the electronic device, to a protection value, wherein the protection value is a function of a value of the configuration bit, and programming of the first enable bit is restricted to the initial state of the electronic device; and
restricting erasing of the first area of the non-volatile memory based on a value of the first enable bit.

19. The non-transitory computer-readable medium of claim 18, wherein the configuration bit is stored in the non-volatile memory.

20. The non-transitory computer-readable medium of claim 18, wherein the contents comprise instructions executable by the processing circuitry.
